(19) United States
(12) Patent Application Publication
(10) Pub. No.: US 2009/0216496 A1
(43) Pub. Date: Aug. 27, 2009

(54) Feeder for a Measuring Transducer for Use in Process Automation Technology

(75) Inventors: Alfred Umkehrer, Hopferau, (DE); Thomas Jögel, Immenstadt (DE); Michael Korn, Marktoberdorf (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Wetzer GmbH Co., KG, Nesselwang (DE)

(21) Appl. No.: 11/887,742

(22) PCT Filed: Mar. 28, 2006
(86) PCT No.: PCT/EP2006/061071

§ 371 Date: Jan. 26, 2009

(30) Foreign Application Priority Data
Apr. 7, 2005 (DE) 10 2005 016 141.3
Jun. 10, 2005 (DE) 10 2005 027 047.6

(51) Int. Cl. G06F 15/00

(52) U.S. Cl. 702/188

(57) ABSTRACT

In a measurement transmitter feeding device for process automation technology, serving for energy, or power, supply of a measurement transmitter and for forwarding electrical current signals transmitted via a signal line between the measurement transmitter and a superordinated unit, additionally arranged in the measurement transmitter feeding device FD are a microcontroller μC connected via a modem to the signal line L and a signalizing means SM activated by the microcontroller μC. The signalizing means SM serves for signalizing additional information delivered from the measurement transmitter MT and transmitted to the microcontroller μC via the signal line L.

The invention relates to a measurement transmitter feeding device for process automation technology.

In process automation technology, field devices are often used to register and/or influence process variables. Examples of such field devices are fill level measuring devices, mass flow measuring devices, pressure and temperature measuring devices, pH-redox potential measuring devices, conductivity measuring devices, etc., which, as sensors, register the corresponding process variables, fill level, flow, e.g. flow rate, pressure, temperature, pH-value and conductivity, respectively.

Serving as field devices for influencing process variables are so-called actuators, e.g. valves, which control flow of a liquid in a section of pipeline or pumps, which change fill level in a container.

A large number of such field devices are manufactured and distributed by the firm Endress+Hauser®.

Frequently, field devices are connected with superordinated units, e.g. control systems or control units. These superordinated units serve for process control, process visualization, process monitoring.

Signal transmission between field devices and superordinated units is done frequently using the known, 4-20 mA standard.

If the field devices involve sensors, then the measured values registered by them are transmitted as an electrical current signal via a signal line to the superordinated units. The measuring range of the sensors is, in such case, linearly mapped onto a 4-20 mA electrical current signal.

Often, the energy, or power, supply of the field devices also is done via the 4-20 mA electrical current signal, so that no additional supply line beyond the signal line is needed.

Normally, this electrical current signal is produced, not in the superordinated unit, but, instead, in a separate measurement transmitter feeding device, which is connected with the signal line (2-wire line).

For utilizing field devices in Ex-areas, certain measures are necessary as regards intrinsic safety. In such case, there is galvanic separation in the transmission of the signals between the control system, which is arranged in a safe area, and the field device, which is arranged in an intrinsically safe area. As a rule, the galvanic separation is effected, likewise, in the measuring transmitter feeding device.

Intelligent field devices possess, in part, comprehensive diagnosis functionalities, which e.g. evaluate the loadings of sensors and actuators, respectively, ascertain when to schedule maintenance and inform the user as to the danger of an impending malfunctioning of the field device.

Such additional information concerning the current state of a sensor cannot be transmitted with conventional 4-20 mA technology, since that permits only transmission of a measured value, or a control signal for a valve.

A presentation of this additional information can, therefore, only be done directly at the field device, when the plant is relying on 4-20 mA technology.

A possibility for transmitting additional information is offered by the HART-standard. In such case, for transmitting digital data, an alternating current signal is superimposed on the analog current signal representing the primary information.

A signalizing of additional information at the control system would only be assured, when a regular transmission of this additional information to the control system would take place. The communication between field devices and control systems occurs in the case of the HART-standard according to the master slave principle, with field devices always functioning as slaves. So, a field device cannot itself initiate the transmitting of additional information to the control system.

Modifying existing applications in control systems to the effect that additional information is queried from the field devices is, in part, very complex.

Also, many control system applications still do not work according to the HART-standard, but are, instead, only designed for an analog 4-20 mA signal transmission.

An object of the invention is to provide that, for field devices connected with a control system via a signal line, additional information of field devices is represented reliably and safely in a unit separate from the field device, without it being necessary that changes be effected at the control system.

The following features given in claim 1 achieve this object.

Measurement transmitter feeding device for process automation technology, serving for energy, or power, supply of a measurement transmitter and for forwarding electrical current signals transmitted via a signal line between the measurement transmitter and a superordinated unit, characterized in that the measurement transmitter feeding device FD includes a microcontroller μC connected via a modem to the signal line L and a signalizing means SM activated by the microcontroller μC, wherein the signalizing means SM serves for signalizing additional information delivered by the measurement transmitter MT and transmitted to the microcontroller μC via the signal line L.

Advantageous further developments of the invention are set-forth in the dependent claims.

An essential idea of the invention is to provide, in a measurement transmitter feeding device, a modem and a microcontroller, with the microcontroller being connected with a signalizing means. In this way, the measurement transmitter feeding device and the measurement transmitter (also referred-to in the literature as a measuring transmitter) can communicate with one another. Additional information is transmitted from the measurement transmitter to the measurement transmitter feeding device and signalized with the aid of the signalizing means.

In a further development of the invention, a separating unit is provided, which serves for galvanic separation of electrical current signals transmitted between measurement transmitter and control system.

In a further development of the invention, the signalizing means is provided in the form of a switch contact and/or as a display element.

The invention will now be explained in greater detail on the basis of an example of an embodiment presented in the drawing, the sole FIGURE of which shows a block diagram of a measurement transmitter feeding device of the invention, combined with a measurement transmitter and a control system.

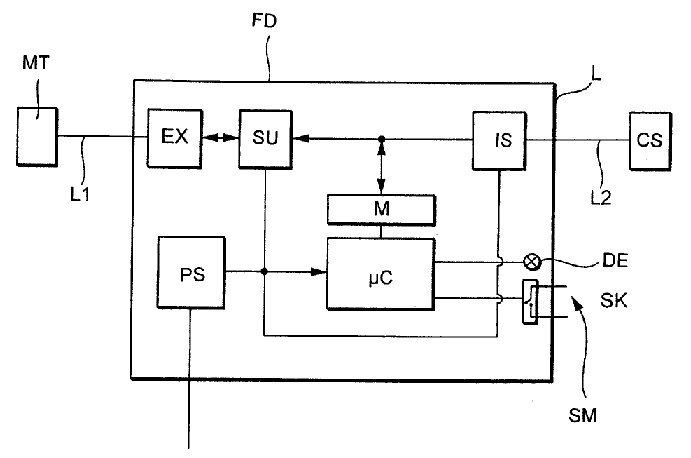

Shown schematically in FIG. 1 are a measurement transmitter feeding device FD, a measurement transmitter MT, and a control system CS serving as superordinated unit. The measurement transmitter MT can be e.g. the temperature sensor TMT 162 of the firm, Endress+Hauser.

Measurement transmitter MT and measurement transmitter feeding device FD are connected with one another via a signal line L. Over this signal line L, which, in principle, is composed of two line sections L1 and L2, a current signal representing a measured value is forwarded from the measurement transmitter MT, via the measurement transmitter feeding device FD, to the control system CS. Each line section is a 4-20 mA current loop.

As in the case of many other measurement transmitter feeding devices, measurement transmitter feeding device FD has, in the signal path from the measurement transmitter MT to the control system CS, a barrier EX corresponding to the specifications for explosion-endangered areas, a separating unit SU for galvanic separation and an electrical current source IS.

According to the invention, provided further in the measurement transmitter feeding device FD are a HART-modem M and a microcontroller μC connected downstream thereof. The microcontroller μC is connected with a signalizing means SM composed of an optical display element DE (e.g. an LED-diode) and a switch contact SK. Serving for energy, or power, supply of the individual components of the measurement transmitter feeding device FD is a power supply PS. The power supply PS serves also for producing the current signal, which supplies the measurement transmitter MT with energy.

The functioning of the measurement system will now be explained in greater detail.

The measurement transmitter MT registers a measured value, which is converted into a 4-20 mA current signal. This current signal is transmitted via the line section L1 to the measurement transmitter feeding device FD and further via the line section L2 to the control system CS.

In the control system CS, e.g., a measured value is visualized, or a control signal is produced for an actuator, as the case may be. If a limit value is exceeded, also an alarm signal can be produced.

The measurement transmitter MT makes available, besides the measured value, also additional information, essentially diagnostic information.

Communication between the measurement transmitter feeding device FD and the measurement transmitter MT occurs, as already mentioned, according to the HART-standard.

In order to obtain the additional information, the measurement transmitter feeding device FD, which functions as master, must query, at regular intervals, the measurement transmitter MT, which serves as slave.

Conceivable are various levels in the additional information delivered by the measurement transmitter MT, such as “in order”, “maintenance recommended”, “maintenance required”, “maintenance urgently required—measured value not safe”.

The association between these individual, different, additional pieces of information and a signalizing can be set e.g. via a not-illustrated switch (e.g. DIP-switch) at the measurement transmitter feeding device FD or via parameters in the parametering of the measurement transmitter feeding device FD.

The additional information is evaluated in the microcontroller μC according to the installed settings and can then be correspondingly signalized by the signalizing means SM acoustically by siren switched via the switch contact SC or optically by the display element DE with an LED-diode.

The measurement transmitter feeding device FD of the invention can be installed easily in existing process plants for signalizing additional information of field devices. Changes at the control systems are, in such case, not needed. The measurement transmitter feeding device FD is, due to its structure, also suitable for intrinsically safe applications. The measurement transmitter feeding device provides a continuous monitoring of the state of a field device connected thereto.

### LIST OF REFERENCE CHARACTERS

TABLE 1

| | |
|---|---|
| Measurement transmitter feeding device | FD |
| Measurement transmitter | MT |
| Control system | CS |
| Signal line | L |
| Separating unit | SU |
| Microcontroller | μC |
| Signalizing means | SM |
| Display element | DE |
| Switch contact | SK |
| Power supply | PS |
| Barrier | EX |
| HART-modem | M |

1-5. (canceled)

6. In a measurement transmitter feeding device for process automation technology, serving for energy, or power, supply of a measurement transmitter and for forwarding electrical current signals transmitted via a signal line between the measurement transmitter and a superordinated unit,
the measurement transmitter feeding device has a microcontroller connected via a modem to said signal line and a signalizing means activated by said microcontroller, said signalizing means serves for signalizing additional information delivered from said measurement transmitter and transmitted to said microcontroller via said signal line.

7. The measurement transmitter feeding device as claimed in claim 6, wherein:
provided in the feeding device is a separating unit, which serves for galvanic separation of the electrical current signals transmitted via said signal line.

8. In the measurement transmitter feeding device as claimed in claim 6, wherein:
signalizing means includes a switch contact and/or a display element.

9. In the measurement transmitter feeding device as claimed in claim 6, wherein:
the electrical current signals are transmitted via 4-20 mA electrical current loops.

10. In the measurement transmitter feeding device as claimed in claim 9, wherein:
the additional information is transmitted via the signal line in digital form as a HART-signal.
